(19) United States
(12) Patent Application Publication
(10) Pub. No.: US 2026/0316511 A1
(43) Pub. Date: Oct. 15, 2026

(54) VEHICLE HEIGHT ADJUSTMENT DEVICE

(71) Applicant: HONDA MOTOR CO., LTD., Tokyo (JP)

(72) Inventors: Atsushi YAMAGAMI, Tokyo (JP); Hiroshi ARAI, Tokyo (JP); Takumi OZAWA, Tokyo (JP); Fumihiro MORISHITA, Tokyo (JP); Takashi NOZAWA, Tokyo (JP); Yuki DOUMAE, Tokyo (JP); Osamu TAKEUCHI, Tokyo (JP)

(21) Appl. No.: 19/640,630

(22) Filed: Apr. 7, 2026

(30) Foreign Application Priority Data
Apr. 9, 2025 (CN) 202510437551.2

(51) Int. Cl. B60G 17/052

(52) U.S. Cl. CPC B60G 17/052; B60G 2400/252; B60G 2400/512; B60G 2500/30; B60G 2800/914

(57) ABSTRACT

This vehicle height adjustment device is mounted in a vehicle including an air spring. The vehicle height adjustment device includes a vehicle height sensor, an air pressure sensor, and an air controller. The vehicle height sensor acquires a measured vehicle height. The air pressure sensor acquires a measured air pressure. The air controller performs predetermined air replenishment control at predetermined time intervals. In the air replenishment control, the air controller attempts air replenishment to the air spring so as to adjust the measured vehicle height to a predetermined target vehicle height, and performs the air replenishment so as to adjust the measured air pressure to a predetermined target air pressure if the measured vehicle height remains below the target vehicle height for a specific period of time or longer.

### CROSS-REFERENCE TO RELATED APPLICATION

This application is based on and claims the benefit of priority from Chinese Patent Application No. CN202510437551.2, filed on 9 Apr. 2025, the content of which is incorporated herein by reference.

### BACKGROUND OF THE INVENTION

### Field of the Invention

The present invention relates to a vehicle height adjustment device for adjusting vehicle height.

### Related Art

Some vehicles are equipped with air springs for absorbing shocks from the road surface using air pressure.

Patent Document 1: Japanese Unexamined Patent Application, Publication No. 2008-94301

### SUMMARY OF THE INVENTION

The inventors of the present invention noted that the following problems may occur when such vehicles are transported using a transport vehicle such as a trailer or a transport vessel. In a case where a vehicle is transported over an extended period of time, air gradually leaks from the air springs, causing a decrease in vehicle height. As a result, the underside of the vehicle body is likely to come into contact with the floor surface at the entrance or the exit of a ramp when the vehicle is unloaded from a transport vehicle or vessel. Furthermore, in a case where the vehicle body of the vehicle is secured to the floor of the transport vehicle or vessel using securing devices such as ropes or lashing belts, the decrease in vehicle height described above may cause a decrease in tension in the securing devices securing the vehicle body to the transport vehicle or vessel.

The inventors of the present invention therefore first considered providing a vehicle height measurement sensor and an air controller described below. The vehicle height measurement sensor measures the vehicle height. The air controller replenishes the air springs with air at predetermined points in time so as to adjust the vehicle height measured by the vehicle height measurement sensor to a predetermined target vehicle height. This configuration makes it possible to automatically replenish the air springs with air at predetermined points in time to restore the vehicle height to the target vehicle height even in a case where the vehicle is transported over an extended period of time.

However, the inventors of the present invention further noted that the following problems may occur. As described above, in some cases of vehicle transportation, the vehicle body is secured to the floor of the transport vehicle or vessel using securing devices such as ropes or lashing belts. In such cases, the vehicle may transition to a "lowered vehicle height state", which is a state where the air springs are compressed, and thus the vehicle height is lowered.

During the lowered vehicle height state, replenishing the air springs with air only increases the air pressure in the air springs and increases the tension in the securing devices that counteracts the air pressure, having little effect on increasing the vehicle height. As such, the above-described control, that is, the control to replenish the air springs with air so as to adjust the measured vehicle height to the target vehicle height, does not operate adequately. Consequently, the air springs cannot be adequately replenished with air.

The present invention was made in view of the foregoing circumstances, and an object thereof is to make it possible to automatically and adequately replenish air springs with air at predetermined points in time during both the lowered vehicle height state described above and a free vehicle height state, which is a state other than the lowered vehicle height state.

The inventors of the present invention found that the object described above could be achieved by replenishing air springs with air in accordance with specific rules, and thus arrived at the present invention. The present invention is directed to a vehicle height adjustment device described in (1) to (5) below.

(1) A vehicle height adjustment device that is mounted in a vehicle equipped with an air spring, the vehicle height adjustment device including: a vehicle height sensor configured to acquire a measured vehicle height, which is a measured value of a vehicle height of the vehicle; an air pressure sensor configured to acquire a measured air pressure, which is a measured value of an air pressure in the air spring; and an air controller configured to perform predetermined air replenishment control at a predetermined point in time. In the air replenishment control, the air controller attempts air replenishment to replenish the air spring with air so as to adjust the measured vehicle height to a predetermined target vehicle height, and performs the air replenishment so as to adjust the measured air pressure to a predetermined target air pressure if the measured vehicle height remains below the target vehicle height for a specific period of time or longer.

According to this configuration, in the air replenishment control, the air controller attempts the air replenishment so as to adjust the measured vehicle height to the target vehicle height. Thus, during the free vehicle height state, it is possible to automatically restore the vehicle height to the target vehicle height through the air replenishment control performed at a predetermined point in time.

In contrast, during the lowered vehicle height state, replenishing the air spring with air only increases the air pressure and has little effect on increasing the vehicle height. The measured vehicle height therefore remains below the target vehicle height for a specific period of time or longer. In this case, the air controller performs the air replenishment so as to adjust the measured air pressure to the target air pressure. Thus, during the lowered vehicle height state, it is possible to automatically restore the air pressure to the target air pressure through the air replenishment control performed at a predetermined point in time.

As described above, according to this configuration, it is possible to automatically and adequately replenish the air spring with air at predetermined points in time during both the lowered vehicle height state and the free vehicle height state.

(2) In the vehicle height adjustment device described in (1), the air controller is configured to switch between a transport mode in which the air controller performs the air replenishment control at the predetermined point in time and a normal mode in which the air controller does not perform the air replenishment control at the predetermined point in time.

According to this configuration, the air controller is set to the transport mode during, for example, transport of the vehicle and to the normal mode otherwise, allowing the air replenishment control to be performed at a predetermined point in time only during transport of the vehicle.

(3) In the vehicle height adjustment device described in (2), the air controller performs the air replenishment control at a plurality of points in time, and in the transport mode, the air controller performs the air replenishment control at predetermined time intervals by performing the air replenishment control again using, as a trigger, elapse of a predetermined replenishment interval after completion of the previous air replenishment control.

According to this configuration, it is possible to efficiently replenish the air spring with air at predetermined time intervals.

(4) In the vehicle height adjustment device described in (2) or (3), the air controller switches to the transport mode based on an operation of selecting the transport mode, the air controller in the transport mode remains in the transport mode even after a vehicle ON operation, which is an operation of enabling the vehicle to travel, or a vehicle OFF operation, which is an operation of disabling the vehicle from traveling, has been performed, and the air controller switches to the normal mode based on an operation of selecting the normal mode.

According to this configuration, the air controller remains in the transport mode even after the vehicle ON operation or the vehicle OFF operation has been performed. This configuration eliminates the concern that the transport mode will be canceled after the vehicle ON operation or the vehicle OFF operation has been performed for loading or unloading the vehicle onto or from a transport vehicle or vessel. The air controller switches to the normal mode based on an operation of selecting the normal mode. This configuration makes it possible to return the air controller to the normal mode soon after the vehicle has been unloaded from the transport vehicle or vessel.

(5) In the vehicle height adjustment device described in any one of (2) to (4), the target vehicle height in the transport mode is set to a height greater than the vehicle height in the normal mode.

When the vehicle is loaded onto or unloaded from a transport vehicle or vessel using a ramp, there is a risk that the underside of the vehicle body is likely to come into contact with the floor surface at, for example, the entrance or the exit of the ramp. In this regard, in this configuration, the target vehicle height is set to a height greater than the vehicle height in the normal mode. As such, the transport mode reduces the risk of the underside of the vehicle body coming into contact with the floor surface.

As described above, according to the configuration described in (1), it is possible to automatically and adequately replenish the air spring with air at predetermined points in time during both the lowered vehicle height state and the free vehicle height state. Furthermore, each of the configurations described in (2) to (5) referring to (1) produces additional effects.

### BRIEF DESCRIPTION OF THE DRAWINGS

FIG. 1 is a diagram illustrating a configuration of a vehicle height adjustment device according to a first embodiment and surroundings thereof;

FIG. 2 is a flowchart showing an example of the flow of air replenishment control;

FIG. 3 is a flowchart showing another example of the flow of the air replenishment control;

FIG. 4 is a diagram illustrating an example of transport of a vehicle in a free vehicle height state; and

FIG. 5 is a diagram illustrating an example of transport of a vehicle in a lowered vehicle height state.

### DETAILED DESCRIPTION OF THE INVENTION

The following describes embodiments of the present invention with reference to the accompanying drawings. However, the present invention is not in any way limited to the following embodiments, and modifications can be made as appropriate within the scope of the gist of the present invention to practice the present invention.

### First Embodiment

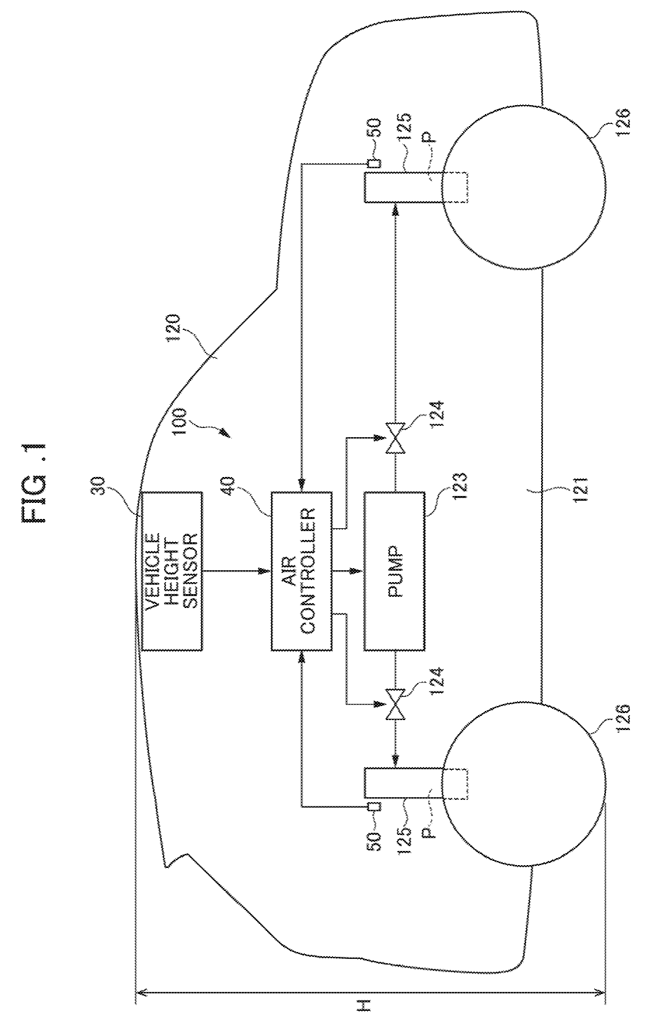

A vehicle height adjustment device 100 shown in FIG. 1 is mounted in a vehicle 120 equipped with air springs 125. The vehicle height adjustment device 100 includes a vehicle height sensor 30, air pressure sensors 50, and an air controller 40.

The vehicle height sensor 30 acquires a "measured vehicle height Hm", which is a measured value of a vehicle height H of the vehicle 120. The air pressure sensors 50 acquires a "measured air pressure Pm", which is a measured value of an air pressure P in each of the air springs 125. The air controller 40 is configured to switch between a predetermined normal mode Mn and a predetermined transport mode Mt.

The air controller 40 performs predetermined air replenishment control in the transport mode Mt. The air controller 40 performs the air replenishment control again using, as a trigger, elapse of a predetermined replenishment interval, such as two days, after completion of the previous air replenishment control. In this way, the air controller 40 in the transport mode Mt performs the air replenishment control at predetermined time intervals, such as every two days.

Each time the air controller 40 performs the air replenishment control, the air controller 40 attempts air replenishment to replenish the air springs 125 with air so as to adjust the measured vehicle height Hm to a predetermined target vehicle height Ho. However, the air controller 40 performs the air replenishment so as to adjust the measured air pressure Pm to a predetermined target air pressure Po if the measured vehicle height Hm remains below the target vehicle height Ho for a specific period of time or longer.

On the other hand, the air controller 40 in the normal mode Mn does not perform the air replenishment control at predetermined points in time.

An operation of enabling the vehicle 120 to travel is referred to below as a "vehicle ON operation". Specifically, the vehicle 120 may be an engine-powered vehicle or an electric vehicle, and examples of vehicle ON operations include an operation of turning on an ignition switch of the engine-powered vehicle and an operation of turning on a power supply for a drive motor of the electric vehicle.

An operation of disabling the vehicle 120 from traveling is referred to below as a "vehicle OFF operation". Specifically, the vehicle 120 may be an engine-powered vehicle or an electric vehicle, and examples of vehicle OFF operations include an operation of turning off an ignition switch of the engine-powered vehicle and an operation of turning off a power supply for a drive motor of the electric vehicle.

The air controller 40 switches to the transport mode Mt based on a user's operation of selecting the transport mode Mt. Examples of users include a driver and an operator. The target vehicle height Ho in the transport mode Mt is set to a height greater than a vehicle height Hn in the normal mode Mn. The air controller 40 in the transport mode Mt remains in the transport mode Mt even after the vehicle ON operation or the vehicle OFF operation has been performed. The air controller 40 switches to the normal mode Mn based on the user’s operation of selecting the normal mode Mn.

The following describes the present embodiment in more detail.

As shown in FIG. 1, the air springs 125 are provided at respective wheels 126. The vehicle 120 is provided with a pump 123 capable of supplying air. The air from the pump 123 is supplied to each air spring 125 via a corresponding valve 124. The vehicle height adjustment device 100 is automatically activated at predetermined time intervals while the air controller 40 is in the transport mode Mt. The air controller 40 performs the air replenishment control by controlling the pump 123 and each valve 124.

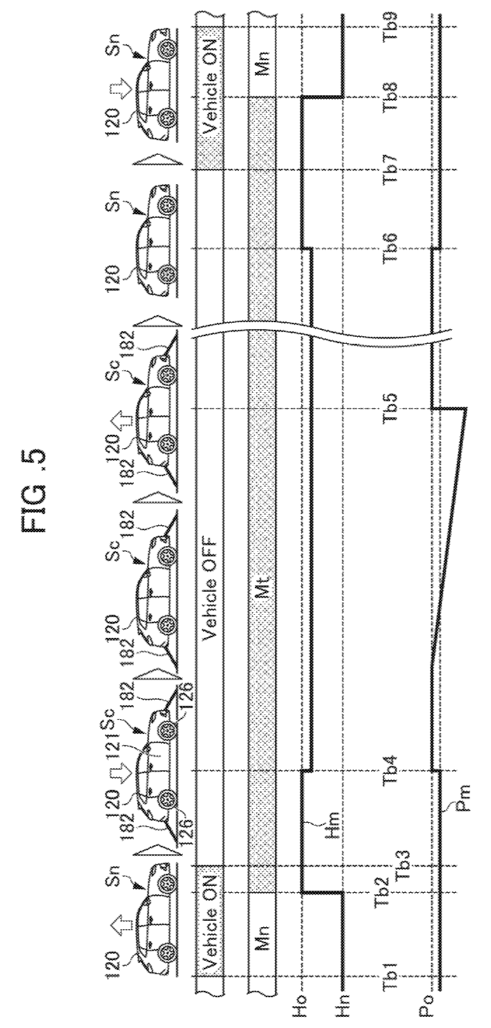

A state where the air springs 125 are compressed and the vehicle height H is lowered due to external forces acting on the vehicle body 121, such as those acting when the vehicle body 121 of the vehicle 120 is secured using ropes, lashing belts, or other securing devices from below as shown in FIG. 5, is referred to below as a "lowered vehicle height state Sc". A state other than the "lowered vehicle height state Sc" is referred to as a "free vehicle height state Sn".

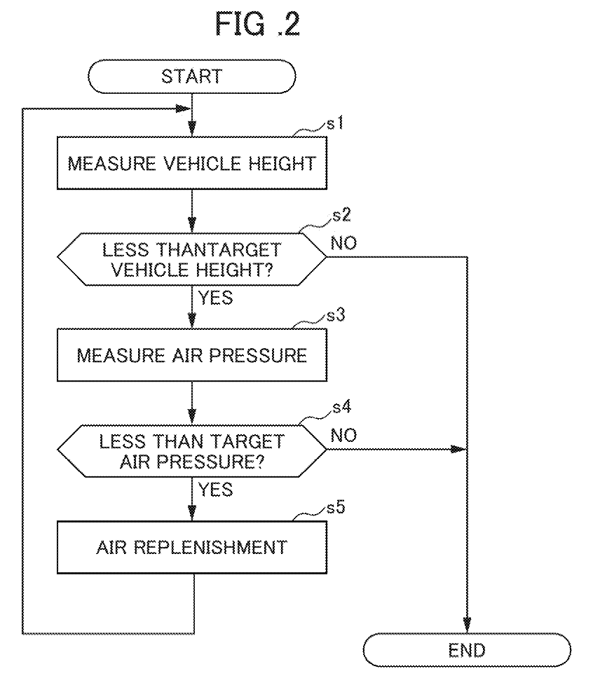

The following describes an example of the flow of the air replenishment control with reference to FIG. 2. It should be noted that the letter "s" preceding numbers below stands for "step".

In this example, in s1, the vehicle height sensor 30 first acquires the measured vehicle height Hm by measuring the vehicle height H. Next, in s2, the air controller 40 determines whether or not the measured vehicle height Hm is less than the target vehicle height Ho. If the result of the determination is negative, that is, if the measured vehicle height Hm has reached the target vehicle height Ho, the air controller 40 terminates the flow and ends the air replenishment control. If the result of the determination in s2 is positive, that is, if the measured vehicle height Hm has not reached the target vehicle height Ho, the process continues to s3.

In s3, each of the air pressure sensors 50 acquires the measured air pressure Pm by measuring the air pressure P of the corresponding air spring 125. Thereafter, in s4, the air controller 40 determines whether or not the measured air pressure Pm is less than the target air pressure Po. If the result of the determination is negative, that is, if the measured air pressure Pm has reached the target air pressure Po, the air controller 40 terminates the flow and ends the air replenishment control. If the result of the determination in s4 is positive, that is, if the measured air pressure Pm has not reached the target air pressure Po, the process continues to s5.

In S5, the air controller 40 replenishes each air spring 125 with a predetermined amount of air by controlling the pump 123 and the corresponding valve 124. Thereafter, the process returns to s1.

During the free vehicle height state Sn, the air replenishment in s5 according to the flow described above increases the vehicle height H but has little effect on increasing the air pressure P. The determination in s4 therefore repeatedly yields a positive result. That is, the measured air pressure Pm never reaches the target air pressure Po. The air replenishment in s5 is therefore repeated until the determination in s2 yields a negative result, that is, until the measured vehicle height Hm reaches the target vehicle height Ho. In this way, the air controller 40 performs the air replenishment so as to adjust the measured vehicle height Hm to the target vehicle height Ho.

In contrast, during the lowered vehicle height state Sc, the air replenishment in s5 increases the air pressure P but has little effect on increasing the vehicle height H. The determination in s2 therefore repeatedly yields a positive result. That is, the measured vehicle height Hm never reaches the target vehicle height Ho. The air replenishment in s5 is therefore repeated until the determination in s4 yields a negative result, that is, until the measured air pressure Pm reaches the target air pressure Po. In this way, the air controller 40 performs the air replenishment so as to adjust the measured air pressure Pm to the target air pressure Po.

As described above, in this example, the air controller 40 attempts the air replenishment so as to adjust the measured vehicle height Hm to the target vehicle height Ho. However, if the measured vehicle height Hm remains below the target vehicle height Ho for a “specific period of time”, which is the time required for the measured air pressure Pm to reach the target air pressure Po, or longer, the air controller 40 performs the air replenishment so as to adjust the measured air pressure Pm to the target air pressure Po.

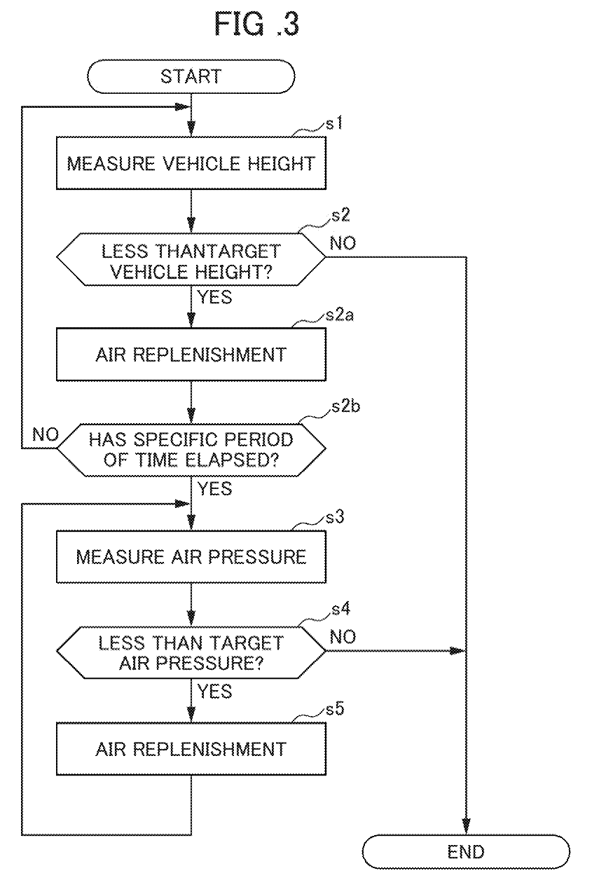

The following describes another example of the flow of the air replenishment control with reference to FIG. 3. S1 and s2 are the same as in the preceding example. If the result of the determination in s2 is positive, that is, if the measured vehicle height Hm has not reached the target vehicle height Ho, the process continues to s2a. In S2a, the air controller 40 replenishes each air spring 125 with a predetermined amount of air.

Subsequently, in s2b, the air controller 40 determines whether or not a predetermined "specific period of time" has elapsed since the start of the air replenishment control. If the result of the determination is negative, the process returns to s1. If the result of the determination is positive, the process continues to s3. S3 to s5 are the same as in the preceding example. The process returns to s3 after s5.

As described above, the air controller 40 also attempts the air replenishment so as to adjust the measured vehicle height Hm to the target vehicle height Ho in the present example. However, if the measured vehicle height Hm remains below the target vehicle height Ho for the predetermined "specific period of time" or longer, the air controller 40 performs the air replenishment so as to adjust the measured air pressure Pm to the target air pressure Po.

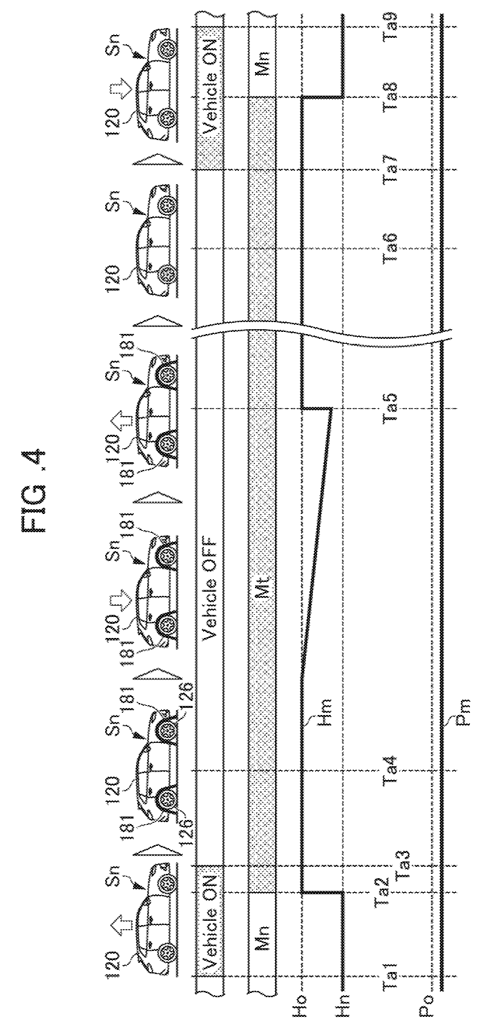

The following describes an example of transport of the vehicle 120 in the free vehicle height state Sn with reference to FIG. 4.

First, the vehicle ON operation is performed at a specific point in time Ta1 while the air controller 40 is in the normal mode Mn. The air controller 40 remains in the normal mode Mn even after this operation. Next, at a subsequent second point in time Ta2, the air controller 40 is switched from the normal mode Mn to the transport mode Mt. As a result, the measured vehicle height Hm increases. After the second point in time Ta2, the vehicle 120 travels to a desired position in a transport vehicle or vessel.

At a subsequent third point in time Ta3, the vehicle OFF operation is performed. The air controller 40 remains in the transport mode Mt even after this operation. At a subsequent fourth point in time Ta4, the wheels 126 of the vehicle 120 are secured to the floor of the transport vehicle or vessel using securing devices 181. As a result, the vehicle 120 is secured to the transport vehicle or vessel while maintaining the free vehicle height state Sn.

After the fourth point in time Ta4, the measured vehicle height Hm gradually decreases as the air within the air springs 125 gradually leaks out. At a subsequent fifth point in time Ta5, the air controller 40 performs the air replenishment control. As a result, the measured vehicle height Hm increases to the target vehicle height Ho. Thereafter, the operations after the fourth point in time Ta4 and at the fifth point in time Ta5 are repeated several times.

At a subsequent sixth point in time Ta6, the vehicle 120 is released from securing. At a subsequent seventh point in time Ta7, the vehicle ON operation is performed. The air controller 40 remains in the transport mode Mt even after this operation. Thereafter, the vehicle 120 travels to a desired position outside the transport vehicle or vessel. At a subsequent eighth point in time Ta8, the air controller 40 is switched from transport mode Mt to the normal mode Mn. As a result, the measured vehicle height Hm decreases. At a subsequent ninth point in time Ta9, the vehicle OFF operation is performed. The air controller 40 remains in the normal mode Mn even after this operation.

The following describes an example of transport of the vehicle 120 in the lowered vehicle height state Sc with reference to FIG. 5.

Operations from a first point in time Tb1 to a third point in time Tb3 are the same as the operations from the first point in time Ta1 to the third point in time Ta3 in the foregoing example of transport of the vehicle 120 in the free vehicle height state Sn. At a subsequent fourth point in time Tb4, the vehicle body 121 of the vehicle 120 is secured to the floor of a transport vehicle or vessel using securing devices 182. As a result, the vehicle 120 transitions to the lowered vehicle height state Sc. As a result, the measured vehicle height Hm decreases and the measured air pressure Pm increases.

After the fourth point in time Tb4, the air pressure P gradually decreases as the air within the air springs 125 gradually leaks out. At a subsequent fifth point in time Tb5, the air controller 40 performs the air replenishment control. As a result, the measured air pressure Pm increases to the target air pressure Po. Thereafter, the operations after the fourth point in time Tb4 and at the fifth point in time Tb5 are repeated several times.

At a subsequent sixth point in time Tb6, the vehicle 120 is released from securing. As a result, the vehicle 120 returns to the free vehicle height state Sn. As a result, the measured vehicle height Hm increases and the measured air pressure Pm decreases. Operations from a subsequent seventh point in time Tb7 to a ninth point in time Tb9 are the same as the operations from the seventh point in time Ta7 to the ninth point in time Ta9 in the foregoing example of transport of the vehicle 120 in the free vehicle height state Sn.

The following summarizes configurations and effects of the present embodiment.

In the air replenishment control that is performed by the air controller 40 shown in FIG. 1, the air controller 40 attempts the air replenishment so as to adjust the measured vehicle height Hm to the target vehicle height Ho. Thus, during the free vehicle height state Sn shown in FIG. 4, it is possible to automatically restore the vehicle height H to the target vehicle height Ho through the air replenishment control performed at predetermined points in time.

In contrast, during the lowered vehicle height state Sc shown in FIG. 5, replenishing the air springs 125 with air only increases the air pressure P and has little effect on increasing the vehicle height H. The measured vehicle height Hm therefore remains below the target vehicle height Ho for a specific period of time or longer. In this case, the air controller 40 performs the air replenishment so as to adjust the measured air pressure Pm to the target air pressure Po. Thus, during the lowered vehicle height state Sc, it is possible to automatically restore the air pressure to the target air pressure Po through the air replenishment control performed at predetermined points in time. Thus, it is possible to prevent the tension in the securing devices securing the vehicle body 121 from decreasing.

As described above, according to the present embodiment, it is possible to automatically and adequately replenish the air springs 125 with air at predetermined points in time during both the free vehicle height state Sn shown in FIG. 4 and the lowered vehicle height state Sc shown in FIG. 5.

The air controller 40 shown in FIG. 1 is configured to switch between the normal mode Mn and the transport mode Mt. In the normal mode, the air controller 40 does not perform the air replenishment control at predetermined points in time. According to the configuration of the present embodiment, the air controller 40 is set to the transport mode Mt during transport of the vehicle 120 and to the normal mode Mn otherwise, allowing the air replenishment control to be performed at predetermined points in time only during transport of the vehicle 120. Thus, this configuration prevents the air replenishment control from being performed unexpectedly while the vehicle 120 is traveling, for example.

Furthermore, the air controller 40 is switched to the transport mode Mt when or immediately before the vehicle 120 is transported. Thus, this configuration eliminates the need for the operator to manually execute air replenishment. This configuration also prevents human error, such as an operator forgetting to execute the air replenishment.

In the transport mode Mt, the air controller 40 performs the air replenishment control again using, as a trigger, elapse of a predetermined replenishment interval after completion of the previous air replenishment control. Thus, this configuration makes it possible to efficiently perform the air replenishment control at predetermined time intervals.

The air controller 40 remains in the transport mode Mt even after the vehicle ON operation or the vehicle OFF operation has been performed. This configuration eliminates the concern that the transport mode Mt will be canceled after the vehicle ON operation or the vehicle OFF operation has been performed for loading or unloading the vehicle 120 onto or from the transport vehicle or vessel. The air controller 40 switches to the normal mode Mn based on an operation of selecting the normal mode Mn. This configuration makes it possible to return the air controller 40 to the normal mode Mn soon after the vehicle 120 has been unloaded from the transport vehicle or vessel.

When the vehicle 120 is loaded onto or unloaded from a transport vehicle or vessel using a ramp, there is a risk that the underside of the vehicle body 121 is likely to come into contact with the floor surface at, for example, the entrance or the exit of the ramp. In this regard, in the present embodiment, the target vehicle height Ho is set to a height greater than the vehicle height Hn in the normal mode Mn. As such, the transport mode Mt reduces the risk of the underside of the vehicle body 121 coming into contact with the floor surface.

### Other Embodiments

The embodiment described above may be, for example, modified as described below. The target vehicle height Ho in the transport mode Mt may be set to the vehicle height Hn in the normal mode Mn, provided that the underside of the vehicle body 121 shown in FIG. 1 is at a sufficient height. In this case, a configuration may be employed in which the air controller 40 does not switch between the transport mode Mt and the normal mode Mn, and is constantly maintained in a single mode corresponding to the transport mode Mt in the first embodiment, provided that the air replenishment control poses no particular problem even if performed while the vehicle 120 is traveling.

### EXPLANATION OF REFERENCE NUMERALS

30: Vehicle height sensor

50: Air pressure sensor

40: Air controller

100: Vehicle height adjustment device

120: Vehicle

125: Air spring

H: Vehicle height

Hm: Measured vehicle height

Hn: Vehicle height in normal mode

Ho: Target vehicle height

P: Air pressure

Pm: Measured air pressure

Po: Target air pressure

What is claimed is:

1. A vehicle height adjustment device that is mounted in a vehicle equipped with an air spring, the vehicle height adjustment device comprising:
a vehicle height sensor configured to acquire a measured vehicle height, which is a measured value of a vehicle height of the vehicle;
an air pressure sensor configured to acquire a measured air pressure, which is a measured value of an air pressure in the air spring; and
an air controller configured to perform predetermined air replenishment control at a predetermined point in time, wherein
in the air replenishment control, the air controller attempts air replenishment to replenish the air spring with air so as to adjust the measured vehicle height to a predetermined target vehicle height, and performs the air replenishment so as to adjust the measured air pressure to a predetermined target air pressure if the measured vehicle height remains below the target vehicle height for a specific period of time or longer.

2. The vehicle height adjustment device according to claim 1, wherein the air controller is configured to switch between a transport mode in which the air controller performs the air replenishment control at the predetermined point in time and a normal mode in which the air controller does not perform the air replenishment control at the predetermined point in time.

3. The vehicle height adjustment device according to claim 2, wherein
the air controller performs the air replenishment control at a plurality of points in time, and
in the transport mode, the air controller performs the air replenishment control at predetermined time intervals by performing the air replenishment control again using, as a trigger, elapse of a predetermined replenishment interval after completion of the previous air replenishment control.

4. The vehicle height adjustment device according to claim 2, wherein
the air controller switches to the transport mode based on an operation of selecting the transport mode,
the air controller in the transport mode remains in the transport mode even after a vehicle ON operation, which is an operation of enabling the vehicle to travel, or a vehicle OFF operation, which is an operation of disabling the vehicle from traveling, has been performed, and
the air controller switches to the normal mode based on an operation of selecting the normal mode.

5. The vehicle height adjustment device according to claim 2, wherein the target vehicle height in the transport mode is
set to a height greater than the vehicle height in the normal mode.
